(19) United States
(12) Patent Application Publication
(10) Pub. No.: US 2002/0068120 A1
(43) Pub. Date: Jun. 6, 2002

(54) METHOD OF EFFECTING IMPROVED CHOCOLATE PROCESSING USING NOBLE GASES

(76) Inventor: KEVIN C. SPENCER, HINSDALE, IL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 08/378,086

(22) Filed: Jan. 25, 1995

Related U.S. Application Data
(63) Continuation of application No. 07/982,464, filed on Nov. 27, 1992, now abandoned.

(51) Int. Cl. A23G 1/00

(52) U.S. Cl. 426/312; 426/631; 426/660

(57) ABSTRACT

A method of improving the aromas and/or the flavor of chocolate or a precursor thereof or a chocolate-containing product comprising injecting a gas or gas mixture into the chocolate, precursor thereof or chocolate-containing product in containing means or into the containing means, container, the gas or gas mixture comprising an element selected from the group consisting of argon, krypton, xenon and neon or a mixture thereof substantially saturating the chocolate, precursor thereof or chocolate containing product with the gas or gas mixture; maintaining said saturation substantially throughout the volume of the storage container and during substantially all the time that the chocolate, precursor or chocolate-containing product is stored in said container.

### BACKGROUND OF THE INVENTION

1. Field of the Invention

The present invention relates to a method of effecting improved chocolate processing using noble gases.

2. Description of the Background

The ability of the noble gases helium (Hi), neon (Ne0< argon (Ar), krypton (Kr), xenon (Xe) and radon (Ra) to enter into chemical combination with other atoms is extremely limited. Generally, only krypton, xenon and radon have been inducted to react with other atoms which are highly reactive, such as fluorine and oxygen, and the compounds thus formed are explosively unstable. See Advanced Inorganic Chemistry, by F. A. Cotton and G. Wilkinson (Wiley, Third Edition). However, while the noble gases are, in general, chemically inert, xenon is known to exhibit certain physiological effects, such as anesthesia. Other physiological effects have also been observed with other inert gases such as nitrogen, which, for example, is known to cause narcosis when used under great pressure in deep-sea diving.

It has been reported in U.S. Pat. No. 3,183,171 to Schreiner that argon and other inert gases can influence the growth rate of fungi and argon is known to improve the preservation of fish or seafood. U.S. Pat. No. 4,946,326 to Schvester, JP 52105232, JP 80002271 and JP 77027699. However, the fundamental lack of understanding of these observations clearly renders such results difficult, if not impossible, to interpret. Moreover, the meaning of such observations is further obscured by the fact that mixtures of many gases, including oxygen, were used in these studies. Further, some of these studies were conducted at hyperbaric pressures and at freezing temperatures. At such high pressures, it is likely that the observed results were caused by pressure damage to cellular components and to the enzymes themselves.

For example, from 1964 to 1966, Schreiner documented the physiological effects of inert gases particularly as related to anesthetic effects and in studies relating to the development of suitable containment atmospheres for deep-sea diving, submarines and spacecraft. The results of this study are summarized in three reports, each entitled: “Technical Report. The Physiological Effects of Argon, Helium and the Rare Gases,” prepared for the Office of Naval Research, Department of the Navy. Contract Nonr 4115(00), NR: 102-597. three later summaries and abstracts of this study were published.

One abstract, “Inert Gas Interactions and Effects on Enzymatically Active Proteins,” Fed. Proc. 26:650 (1967), restates the observation that the noble and other inert gases produce physiological effects at elevated partial pressures in intact animals (narcosis) and in microbial and mammalian cell systems (growth inhibition).

A second abstract, “A Possible Molecular Mechanism for the Biological Activity of Chemically Inert Gases,” In: Intern. Congr. Physiol. Sci., 23rd, Tokyo, restates the observation that the inert gases exhibit biological activity at various levels of celluar organization at high pressures.

Also, a summary of the general biological effects of the noble gases was published by Schreiner in which the principal results of his earlier research are restated. “General Biological Effects of the Helium-Xenon Series of Elements,” Fed. Proc. 27:872-878 (1968).

However, in 1969, Behnke et al refuted the major conclusions of Schreiner. Behnke et al concluded that the effects reported earlier by Schreiner are irreproducible and result solely from hydrostatic pressure, i.e., that no effects of noble gases upon enzymes are demonstrable. “Enzyme-Catalyzed Reactions as Influenced by Inert Gases at High Pressures.” J. Food Sci. 34:370-375.

In essence, the studies of Schreiner were based upon the hypothesis that chemically inert gases compete with oxygen molecules for cellular sites and that oxygen displacement depends upon the ratio of oxygen to inert gas concentrations. This hypothesis was never demonstrated as the greatest observed effects (only inhibitory effects were observed) were observed with nitrous oxide and found to be independent of oxygen partial pressure. Moreover, the inhibition observed was only 1.9% inhibition per atmosphere of added nitrous oxide.

In order to refute the earlier work of Schreiner, Behnke et al independently tested the effect of high hydrostatic pressures upon enzymes, and attempted to reproduce the results obtained by Schreiner. Behnke et al found that increasing gas pressure of nitrogen or argon beyond that necessary to observe a slight inhibition of chymotrypsin, invertase and tyrosinase caused no further increase in inhibition, in direct contract to the finding of Schreiner.

The findings of Behnke et al can be explained by simple initial hydrostatic inhibition, which is released upon stabilization of pressure. Clearly, the findings cannot be explained by the chemical—O₂/inert gas interdependence as proposed by Schreiner. Behnke et al concluded that high pressure inert gases inhibit tyrosinase in non-fluid (i.e., gelatin) systems by decreasing oxygen availability, rather than by physically altering the enzyme. This conclusion is in direct contrast to the findings of Schreiner.

In addition, to the refutation by Behnke et al, the results reported by Schreiner are difficult, if not impossible, to interpret for other reasons as well.

first, all analyses were performed at very high pressure, and were not controlled for hydrostatic pressure effects.

Second, in many instances, no significant differences were observed between the various noble gases, nor between the noble gases and nitrogen.

Third, knowledge of enzyme mode of action and inhibition was very poor at the time of these studies, as were the purities of enzymes used. It is impossible to be certain that confounding enzyme actives were not present or that measurements were made with a degree of resolution sufficient to rank different gases as to effectiveness. Further, any specific mode of action could only be set forth as an untestable hypothesis.

Fourth, solubility differences between the various gases were not controlled, nor considered in the results.

Fifth, all tests were conducted using high pressures of inert gases superimposed upon 1 atmosphere of air, thus providing inadequate control of oxygen tension.

Sixth, all gas effects reported are only inhibitions.

Seventh, not all of the procedures in the work have been fully described, and may not have been experimentally controlled. further, long delays after initiation of the enzyme reaction precluded following the entire course of reaction, with resultant loss of the highest readable rates of change.

Eighth, the reported data ranges have high variability based upon a small number of observations, thus precluding significance.

Ninth, the levels of inhibition observed are very small even at high pressures.

Tenth, studies reporting a dependence upon enzyme concentration do not report significant usable figures.

Eleventh, all reports of inhibitory potential of inert gases at low pressures, i.e., <2 atm., are postulated based upon extrapolated lines from high pressure measurements, not actual data.

Finally, it is worthy of reiterating that the results of Behnke et al clearly contradict those reported by Schreiner in several crucial respects, mainly that high pressure effects are small and that hydrostatic effects, which were not controlled by Schreiner, are the primary cause of the incorrect conclusions made in those studies.

Additionally, although it was reported by Sandhoff et al, FEBS Letters, vol. 62, no. 3 (March, 1976) that xenon, nitrous oxide and halothane enhance the activity of particulate sialidase, these results are questionable due to the highly impure enzymes used in this study and are probably due to inhibitory oxidases in the particles.

To summarize the above patents and publications and to mention others related thereto, the following is noted.

Behnke et al (1969), discloses that enzyme-catalyzed reactions are influenced by inert gases at high pressures. J. Food Sci. 34: 370-375.

Schreiner et al (1967), describe inert gas interactions and effects on enzymatically, active proteins. Abstract No. 2209. Fed. Proc. 26:650.

Schreiner, H. R. 1964, Technical Report, describes the physiological effects of argon, helium and the rare gases. Contract Nonr 4115 (900), NR: 102-597. Official of Naval Research, Washington, D.C.

Schreiner, H. R. 1965, Technical Report, describes the physiological effects of argon, helium and the rare gases. Contract Nonr 4115 (00), NR: 102-597. Office of Naval Research, Washington, D.C.

Schreiner, H. R. 1966, Technical Report, describes the physiological effects of argon, helium and the rare gases. Contract Nonr 4115 (00), NR: 102-597. Office of Naval Research, Washington, D.C.

Doebbler, G.F. et al, Fed. Proc. vol. 26, page 650 (1967), describes the effect of pressure or of reduced oxygen tension upon several different enzymes using the gases Kr, Xe, SF₆, N₂O, He, Ne, Ar and N₂. All gases were considered equal in their effect.

Colten et al, Undersea Biomed. Res. 17(4), 297-304 (1990), describes the combined effect of helium and oxygen with high pressure upon the enzyme glutamate decarboxylase. Notably, only the hyperbaric inhibitory effect of both helium and oxygen and the chemical inhibitory effect of oxygen was noted.

Nevertheless, at present, it is known that enzyme activities can be inhibited in several ways. For example, many enzymes can be inhibited by specific poisons that may be structurally related to their normal substrates. Alternatively, many different reagents are known to be specific inactivators of target enzymes. These reagents generally cause chemical modification at the active site of the enzyme to induce loss of catalytic activity, active-site-directed irreversible inactivation or affinity labeling. See Enzymatic Reaction Mechanisms by C. Walsh (W. H. Freeman & Co., 1979). Alternatively, certain multi-enzyme sequences are known to be regulated by particular enzymes known as regulatory or allosteric enzymes. See Bioenergetics, by A. L. Leninger (Benjamin/Cummings Pulbishing Co., 1973).

However, it would be extremely advantageous if a much simpler approach could be attained for regulating enzyme activities in a predicable and controllable manner. Moreover, it would be extremely advantageous if a means could be found for selectively inhibiting or enhancing enzyme activities in a predicable and controllable manner.

Cocoa is very expensive, and the process yield thereof is critically important. Even when conventional processes are optimized, however, significant losses in quality and effective yield occur during uncontrolled oxidation at several steps of the process, especially those steps involving cocoa liquor or butter. In the finished product, oxidative instability contributes quite strongly to off-flavors, bad appearance, and limited shelf life. Other important quality parameters are also deleteriously affected by oxidative instability. While oxygen from air is responsible for a portion of the oxidation, catalysts for oxidation and oxygen sources exist in the product and process stream as well. While blanketing with nitrogen or other inert gas is effective for merely removing air, it is not effective to inhibit internal oxidations in addition to air oxidation.

Thus, a need exists for a method by which internal oxidation as well as air oxidation of chocolate may be inhibited.

### SUMMARY OF THE INVENTION

In accordance with the present invention, a method is provided for effecting improved chocolate processing in the presence of at least one noble gas.

Further, a method is also provided for inhibiting the oxidative degradation of chocolate or a precursor thereof before, during or after processing.

The above objects and others are provided by a method of improving a process for producing chocolate, which entails injecting a gas or gas mixture into liquid chocolate or in headspace of solid chocolate or a precursor of either in containing means during production into the containing means containing the same, the gas or gas mixture containing an element selected from the group consisting of argon, krypton, xenon, neon and a mixture thereof; substantially saturating the liquid chocolate or precursor thereof or headspace of solid chocolate or precursor thereof with the gas or gas mixture; and maintaining the saturation substantially throughout the volume of the containing means and during substantially all of the duration that the chocolate is produced.

### DETAILED DESCRIPTION OF THE PREFERRED EMBODIMENTS

In accordance with the present invention, it has been surprisingly discovered that either liquid or solid chocolate or a precursor thereof can be preserved by inhibiting oxidative degradation thereof by saturating or substantially saturating the chocolate or the precursor thereof during at least one processing step therefor and/or storage step thereof with at least one noble gas, a mixture of noble gases or a gas mixture containing at least one noble gas. The effect of oxidative inhibition is provided not only by displacement of oxygen but also by action of the noble gas at the molecular level.

As used herein, the term “noble gas” means any one of argon, krypton, xenon or neon. Helium does not word and radon is radioactive and not useful. Preferably, argon or mixtures containing argon are used. Further, any of these gases may be used singly, or in combination with each other or in admixture with inert gases, such as nitrogen.

Generally, the present invention may be practiced during any single stage, any combination of stages or throughout all stages of chocolate production, processing and/or storage. Further, it may be utilized in conjunction with the subsequent production of any product containing chocolate. For example, the present invention may be used to great advantage in the production and/or processing of chocolate liquor, cocoa cake from processing, chocolate powder, chocolate beans or nibs, candies, cocoa butter or any other intermediate finished chocolate product or confectionery.

The present invention may also be used for preserving a chocolate precursor. As used herein, by “precursor” is meant any natural product such as cacao beans or raw cocoa which may be used as a source of chocolate.

Generally, the present invention affords a variety of surprising advantages. For example, surprising improvement and/or enhancement is noted in the profile of chemical components, flavor, fragrance (aroma), thermostability (temper), shelf life, consistency, color, texture, overall appearance and customer appeal. In general, improvements and/or enhancements of at least 20% in many or all of these categories is observed using the present invention.

Although the effect of the present invention may be obtained even with the application of very low pressures or partial pressures of one or more noble gases, the effect generally increases with increasing pressures or partial pressures of the noble gases. While pressures from about 10⁻⁸ torr to 100 atm. may be used, in general, pressures of from 10⁻² atm. to about 10 atm. are more commonly used. However, it is preferred to use from about 10⁻¹ atm. To about 3 atm. of pressure. It is more preferred still to use from about 0.5 atm. to about 2 atm. of pressure. Generally, excellent results may be obtained at ambient or about 1 atm. of pressure.

However, the present method is effective particularly at the pressures found in typical process steps, such as 12,000 psi in a pressurizing step, and 3 to 6 atm. in the roasting step, for example.

As noted above, the present invention may be used advantageously in conjunction with any single stage or multiple stages of chocolate production and/or processing. The general process for the production of chocolate will now be described. The present invention may be used in conjunction with any or all of these steps or with any steps with those required for the production of products containing chocolate.

Generally, chocolate processing involves a long series of steps during which oxidation can occur causing damage to the final product. The steps are generally as follows: 1) cocoa beans are picked, often by hand; 2) the beans are fermented, in piles or trays; 3) the fermented beans are stored and/or transported to a processing facility; 4) the beans are cleaned, washed, brushed, and undesirable particles are separated out by airlift separators and magnetic separators 5) the fermented beans are roasted in hot air flow ovens, or by convection 4) or micronizer treatments 6) the roasted beans are sterilized; 7) the sterile beans are subjected to alkalization by treatment with K₂CO₃ in order to confer desired color; 8) the alkalized beans are winnowed to remove shells, and the nibs are separated and retained, by a combined breaker/sieve/airlift 9) cocoa is produced through expeller/extrusion or more commonly through milling of beans and nibs through grinding and use of heat (both external and from friction); 10) the liquor is subject to heat devolatilization, thin film roasting (with or without vacuum) and air scrubbing; 11) alkalization (“Dutching”) is carried out; 12) liquor is pressed, often in a horizontal hydraulic press at 12,000 psi and 95-105° C. to produce “cake”. The moisture content is critical and needs to be maintained between 0.8-1.8%, or at an even narrower range of between 1-1.5%. Alternatively, pressing can be by expeller extrusion screw pressing. Solvent extraction can also be carried out; 13) the cake is then ground (“kibbled”) in various mills and cooled to yield cocoa powder. The composition of the cocoa powder (Table 1) is critical, especially the fat or butter content and composition (Table 2). Lecithin content and deodorization effects are also important. A viscometer is used to measure butter . Replacement fats may be used, measured as cocoa butter equivalents (e.g. lauric or nonlauric cocoa butter replacers; 14) The powder is then subject to hopper mixing and refining; 15) milk crumb may be mixed with the cocoa powder to produce milk chocolate. Milk crumb is made by evaporation, kneading and drying of milk; 16) The final step in chocolate production is conching which is rolling of chocolate as a semisolid in a lapping mortar/pestle type of device.

Subsequent steps may be used to utilize chocolate in the production of confectionery. These steps may include addition of cocoa butter replacements, addition of antibloom agents such as sorbitan and polyoxyethylene fatty esters (Span/Tween), tempering and cooling, molding, drop and roller deposition, aeration, flake and bark formation, vermicelli production, lamination, hollow rotation, foiling, shelling, molding, enrobing, cooking, coating and panning.

Generally, all of the above steps, but particularly steps 9-16, entail contact of the chocolate with air. Removing the air with an inert gas like nitrogen offers some improvement in reducing oxidation however, the reduction is only for oxidation due to air oxidation and not for internal oxidation. By applying the present invention to any or all of these process steps, an inhibiting effect against internal oxidation is obtained. This effect can be realized even in the presence of small amounts of oxygen.

In general, the present invention entails contact, and preferably the saturation of, chocolate with the gases of the present invention, preferably with argon, at any stage, more preferably at every stage, of its production in order to inhibit the oxidative degradation of the chocolate.

Generally, when the chocolate is in the form of a liquid or the precursor is generally in liquid form, the following will apply.

Notably, if instead of solely blanketing the space above liquid chocolate or precursor in a tank or a bottle with any kind of inert gas, a gas selected from the group consisting of argon, krypton, xenon and neon or a mixture thereof is sparged into the chocolate and/or injected above the liquid chocolate or precursor in order to saturate or substantially saturate the same with said gas or gas mixture, it is possible to substantially improve the color and/or the flavor and/or the aroma and/or the shelf life of the chocolate, particularly when said saturation or substantial saturation is maintained throughout the volume of the storage container and during substantially all the time that the chocolate is stored in said container.

The term “substantially saturate” means that it is not necessary to completely and/or constantly saturate the liquid chocolate or precursor with the gas or gas mixture (i.e., having the maximum amount of gas solubilized in said wine). Usually, it is considered necessary to saturate said wine to more than 50% of its (full) saturation level and preferably more than 70%, while 80% or more is considered the most adequate level of saturation of the chocolate. Of course, supersaturation is also possible. This means that if during the storage life of the chocolate in the container, the chocolate is not saturated with noble gas at least from time to time or even quite longer if it remains generally substantially saturated, results according to the invention are usually obtained. While it is believed that it is important that the entire volume of the container be saturated or substantially saturated with one of the above gas or a mixture thereof, it is quite possible to obtain the results according to the invention if a part of the volume is not saturated during preferably a limited period of time or is less saturated or substantially saturated than other portions of the volume of the chocolate in the container.

While at least one of the above gases must be present in order to obtain the benefits of the invention, said gases can be diluted with some other gases, in order to keep for example the invention economically valuable. Said diluent gases are preferably selected from the group comprising nitrogen, oxygen, nitrous oxide, air, helium or carbon dioxide. In case of an oxygen-containing gas or another reactive gas such as carbon dioxide, their degradative properties are such that these properties will mask the effect of noble gases, certainly in mixtures where they comprise 50% vol. or more and possibly 30% vol. or more. When those mixes comprise 0% to 10% vol. of these other gases, the noble gases referred to above are still extremely effective, while between 10% vol. and 20% vol. they are usually still effective, depending on the type of gases and conditions, which might be easily determined by the man skilled in the art.

In case of nitrogen and/or helium gas, the effect of noble gases consisting of Ar, Ne, Kr, Xe in the mixture is linearly proportional to its concentration in the mixture, which evidences that nitrogen and/or helium have no effect on substantially preventing oxidation of the chocolate. The mixture of noble gas and nitrogen and/or helium can thus comprise any amount (% volume) of nitrogen and/or helium: however, in practice, the lesser the proportion of noble gas selected from the group consisting of Ar, Ne, Kr and Xe, the larger the time required to achieve saturation or substantial saturation of the chocolate.

Among the active gases (Ar, Kr, Xe, and Ne), it is preferred to use argon because it is cheaper than the other active gases. However, mixtures of argon and/or krypton and/or xenon are at least as effective as argon alone. It has also been unexpectedly found that mixtures comprising between 90 to 99% vol. argon and 1 to 10% Xe and/or Kr are usually the most effective as exemplified in the further examples (whether or not they are diluted with nitrogen, helium, or nitrous oxide). The difference in effect between the active gases defined hereabove and nitrogen have been also evidenced by the fact that mixtures of argon and oxygen or carbon dioxide have a similar (while decreased) effect than argon alone, while nitrogen mixed with oxygen or carbon dioxide evidenced no protective or preservative effect compared to oxygen or carbon dioxide alone.

It is believed that the saturation or substantial saturation of the chocolate is an essential feature of the invention and that no one in the prior art has ever disclosed nor suggested said feature.

Generally speaking, Xe is the most efficient gas according to the invention, followed by Kr, Ar and Ne. Among the suitable mixes, either pure or diluted with N₂, He, N₂O (or even air, oxygen or a small amount of hydrogen) are the Ne/He mix comprising about 50% vol. of each, and the Kr/Xe mix comprising about 5-10% vol. Xe and about 90-95% vol. Kr, with a small amount of argon and/or oxygen (less than 2% vol.) or nitrogen (less than 1% vol.).

The temperatures at which the invention is carried out is usually between about 0° C. to 60° C., and preferably about 10° C. and 30° C.

The injection of the gas or gas mixture into the wine and/or into the container, e.g. by sparging is usually done at about 1 atmosphere but is still quite operable at 2 or 3 atmospheres, while saturation is increased at higher pressures. The pressure of the gas above the wine in the container shall be, in any case, preferably lower than 10 atmospheres and it is usually acceptable to maintain it lower than 3 atmospheres.

Saturation or substantial saturation of the chocolate can be measured by various methods well-known by the man skilled in the art, including but not limited to thermogravimetric analysis or mass change weighting.

There are a variety of standard methods available for the detection, qualitative and quantitative measurement of gases, and several are especially well suited for the determination of degree of saturation of noble gases into liquid samples.

Samples generally are completely evacuated as a control for zero % saturation. Such samples may then be completely saturated by contact with noble gases such that no additional noble gas will disappear from a reservoir in contact with the sample. Such saturated samples may then have their gas content driven off by trapped evacuation or by increase in temperature, and said gas sample identified quantitatively and qualitatively. Analysis is of trapped gases, reservoir gases, or some other headspace of gases, not directly of the sample.

Direct sample analysis methods are available, and include comprehensive GC/MS analysis, or by mass or thermal conductance or GC analysis and comparison with calibrated standards.

The simplest method is GC/MS (gas chromatography/mass spectrometry), which directly determines gas compositions. By preparing a standard absorption curve into a given sample for a series of gases and mixtures, one can accurately determine the degree of saturation at any point in time.

GC/MS is applied to the gas itself, as in the headspace above a sample. The technique may be used either to determine the composition and quantity of gas or mixture being released from a sample, or conversely the composition and quantity of a gas or mixture being absorbed by a sample by following the disappearance of the gas.

Appropriate GC/MS methods include, for example, the use of a 5 Angstrom porous layer open tubular molecular sieve capillary glass column of 0.32 mm diameter and 25 meter length to achieve separation, isothermally e.g. at 75° C. or with any of several temperature ramping programs optimized for a given gas or mixture e.g. from 35-250° C., wherein ultra-high purity helium or hydrogen carrier gas is used at e.g. 1.0 cc/min flow rate, and gases are detected based upon their ionicity and quantitative presence in the sample, and characterized by their unique mass spectra.

Appropriate experimental conditions might include, for example, completely evacuating a given sample under vacuum to remove all absorbed and dissolved gases, then adding a gas or mixture to the sample and measuring a) the rate of uptake of each component as disappearance from the added gas, and/or b) the final composition of the gas headspace after equilibration. Both measurements are made by GC/MS, and either method can be used in both batch and continuous modes of operation.

A simplification of this analysis entails the use of a GC only, with a thermal conductivity detector, wherein adequate knowledge of the gas saturation process and preparation of calibration curves have been made such that quantification and characterization of gases and mixtures can be accomplished without mass spectral analysis. Such instruments are relatively inexpensive and portable.

A further simplification would depend solely upon measurement of the mass change in the sample upon uptake of various gases or mixtures, which depends upon the use of standard curves or absorption data available from the literature.

An alternate method for such mass measurements is thermogravimetric analysis, which is highly precise, wherein a sample is saturated with gas and mass changes are correlated to thermal change.

When the chocolate or precursor is in solid form, however, the following will generally apply.

Namely, for solid chocolate, it has been unexpectedly discovered that, if instead of blanketing the space above the solid chocolate or solid precursor stored in a container with any kind of inert gas, a gas selected from the group consisting of argon, krypton, xenon and neon or a mixture thereof is sparged into the chocolate and/or injected above the chocolate in order to saturate or substantially saturate the chocolate with the gas or gas mixture, it is possible to substantially improve the flavor and/or the aroma and/or the shelf life of the chocolate, particularly when said saturation or substantial saturation is maintained throughout the volume of the storage container and during substantially all the time that the chocolate is stored in said container.

The term “substantially saturate” means that it is believed that it is not necessary to completely and/or constantly saturate the chocolate with said gas or gas mixture (i.e., having the maximum amount of gas solubilized in said chocolate). Usually, it is considered necessary to saturate said chocolate to more than 50% of its (full) saturation level and preferably more than 70%, while 80% or more is considered the most adequate level of saturation of the chocolate. Of course, supersaturation is also possible. This means that if during the storage life of the chocolate in the container, the chocolate is not saturated with noble gas at least from time to time or even quite longer if it remains generally substantially saturated, results according to the invention are usually obtained. While it is believed that it is important that the entire volume of the container be saturated or substantially saturated with one of the above gas or a mixture thereof, it is quite possible to obtain the results according to the invention if a part of the volume is not saturated during preferably a limited period of time or is less saturated or substantially saturated than other portions of the volume of the chocolate in the container.

While at least one of the above gases must be present in order to obtain the benefits of the invention, said gases can be diluted with some other gases, in order to keep for example the invention economically valuable. Said diluent gases are preferably selected from the group comprising nitrogen, oxygen, nitrous oxide, air, helium or carbon dioxide. In case of an oxygen-containing gas or another reactive gas such as carbon dioxide, their degradative properties are such that these properties will mask the effect of noble gases, certainly in mixtures where they comprise 50% vol. or more and possibly 30% vol. or more. When those mixes comprise 0% to 10% vol. of these other gases, the noble gases referred to above are still extremely effective, while between 10% vol. and 20% vol. they are usually still effective, depending on the type of gases and conditions, which might be easily determined by the man skilled in the art.

In case of nitrogen and/or helium gas, the effect of noble gases consisting of Ar, Ne, Kr, Xe in the mixture is linearly proportional to its concentration in the mixture, which evidences that nitrogen and/or helium have no effect on substantially preventing oxidation of chocolate. The mixture of noble gas and nitrogen and/or helium can thus comprise any amount (% volume) of nitrogen and/or helium: however, in practice, the lesser the proportion of noble gas selected from the group consisting of Ar, Ne, Kr and Xe, the larger the time required to achieve saturation or substantial saturation of the chocolate.

Among the active gases (Ar, Kr, Xe, and Ne), it is preferred to use argon because it is less expensive than the other active gases. However, mixtures of argon and/or krypton and/or xenon are at least as effective as argon alone. It has also been unexpectedly found that mixtures comprising between 90 to 99% vol. argon and 1 to 10% Xe and/or Kr are usually the most effective as exemplified in the further examples (whether or not they are diluted with nitrogen, helium, or nitrous oxide). The difference in effect between the active gases defined hereabove and nitrogen have been also evidenced by the fact that mixtures of argon and oxygen or carbon dioxide have a similar (while decreased) effect than argon alone, while nitrogen mixed with oxygen or carbon dioxide evidenced no protective or preservative effect compared to oxygen or carbon dioxide alone.

It is believed that the saturation or substantial saturation of the chocolate is an essential feature of the invention and that no one in the prior art has ever disclosed nor suggested said feature.

Generally speaking, Xe is the most efficient gas according to the invention, followed by Kr, Ar and Ne. Among the suitable mixes, either pure or diluted with N₂, He, N₂O (or even air, oxygen or a small amount of hydrogen) are the Ne/He mix comprising about 50% vol. of each, and the Kr/Xe mix comprising about 5-10% vol. Xe and about 90-95% vol. Kr, with a small amount of argon and/or oxygen (less than 2% vol.) or nitrogen (less than 1% vol.).

The temperatures at which the invention is carried out is between about 0° C. to about 600° C. or more. Preferably for some processing steps, a temperature from about 200° C. to about 600° C. is usually used, while for most processing and storage steps, a temperature between about 20° C. and about 40° C. It is also possible to introduce the gas or gas mixture as a cryogenic liquid, which is either vaporized and heated before using it or used as such to freeze the chocolate or precursor thereof.

The injection of the gas or gas mixture into the coffee and/or into the storage container, e.g. by sparging is usually done at about 1 atmosphere but is still quite operable at 2 or 3 atmosphere, while saturation is increased at higher pressures. The pressure of the gas above the chocolate in the storage container shall be, in any case, preferably lower than 3 atmosphere and it is usually acceptable to maintain it lower than 2 atmosphere. A slight overpressure (between 1 or 2 atmosphere) is usually sufficient.

However, the gases or gas mixes according to the invention are entirely effective near vacuum or between vacuum and atmospheric pressure, provided that such gas can saturage or substantially saturate the chocolate, the effect of said gas or gases or gas mixes being a fraction of its effect at 1 atmosphere. In case of processing chocolate, a higher pressure may be used up to 100 atmosphere but usually less than 10 atmosphere and preferably between 1 and 6 atmosphere.

In every case, the optimal method is to saturate or substantially saturate the product with noble gas selected from the group defined hereabove as completely as possible.

There are a variety of standard methods available for the detection, qualitative and quantitative measurement of gases, and several are especially well suited for the determination of degree of saturation of noble gases into solid samples.

Samples generally are completely evacuated as a control for zero % saturation. Such samples may then be completely saturated by contact with noble gases such that no additional noble gas will disappear from a reservoir in contact with the sample. Such saturated samples may then have their gas content driven off by trapped evacuation or by increase in temperature, and said gas sample identified quantitatively and qualitatively. Analysis is of trapped gases, reservoir gases, or some other headspace of gases, not directly of the sample.

Direct sample analysis methods are available, and include comprehensive GC/MS analysis, or by mass or thermal conductance or GC analysis and comparison with calibrated standards.

The simplest method is GC/MS (gas chromatography/mass spectrometry), which directly determines gas compositions. By preparing a standard absorption curve into a given sample for a series of gases and mixtures, one can accurately determine the degree of saturation at any point in time.

GC/MS is applied to the gas itself, as in the headspace above a sample. The technique may be used either to determine the composition and quantity of gas or mixture being released from a sample, or conversely the composition and quantity of a gas or mixture being absorbed by a sample by following the disappearance of the gas.

Appropriate GC/MS methods include, for example, the use of a 5 Angstrom porous layer open tubular molecular sieve capillary glass column of 0.32 mm diameter and 25 meter length to achieve separation, isothermally e.g. at 75° C. or with any of several temperature ramping programs optimized for a given gas or mixture e.g. from 35-250° C., wherein ultra-high purity helium or hydrogen carrier gas is used at e.g. 1.0 cc/min flow rate, and gases are detected based upon their ionicity and quantitative presence in the sample, and characterized by their unique mass spectra.

Appropriate experimental conditions might include, for example, completely evacuating a given sample under vacuum to remove all absorbed and dissolved gases, then adding a gas or mixture to the sample and measuring a) the rate of uptake of each component as disappearance from the added gas, and/or b) the final composition of the gas headspace after equilibration. Both measurements are made by GC/MS, and either method can be used in both batch and continuous modes of operation.

A simplification of this analysis entails the use of a GC only, with a thermal conductivity detector, wherein adequate knowledge of the gas saturation process and preparation of calibration curves have been made such that quantification and characterization of gases and mixtures can be accomplished without mass spectral analysis. Such instruments are relatively inexpensive and portable.

A further simplification would depend solely upon measurement of the mass change in the sample upon uptake of various gases or mixtures, which depends upon the use of standard curves or absorption data available from the literature.

An alternate method for such mass measurements is thermogravimetric analysis, which is highly precise, wherein a sample is saturated with gas and mass changes are correlated to thermal change.

In so doing, contacting by shrouding, blanketing, pressure treatment, sparging, or cryogenic contact may be practiced. Further, saturation is desirable and complete saturation optimal. Pressure improves the effect by increasing saturation. Improvement is dramatic for both processing and storage.

Moreover, the present invention may be used in conjunction with any apparatus or device which is used either directly or indirectly in the production or storage of chocolate or products subsequently produced therefrom containing chocolate.

For example, the present invention may be used in conjuction with separators; magnetic separators; destoners; fluid bed roasters, where beans are heated by convection; probat roasters, where beans are prewarmed, roasted and cooled by convection; Buhler STR 2 roasters, micromizers, tornado roasters, particularly model 2600 RS; winnowing machines, for sieving beans; triple liquor mills, cocoa mills, particularly Type MPH 411; Wieneroto W45C, Petzhold+Injection Unit Type PIA; Petsomat-Single Tower; LBCT System: Dutching Plant; liquor presses; cocoa butter extractors, particularly those of a continuous nature; powder cooling and stabilizing systems; cocoa butter deodorizing plants; Buhler Automatic Hopper System, Mixing and Double Refining Systems; Groen Crumb System Pilot Plants; Conche pots, particularly four-pot conches; Petzholdt Superconche type PVS; Rotary conche; Frisse Double-Overthrow Conche; Tourell-Garclner Conche; Macintyre Refiner Conche; Wiener Process Installations; Wieneroto Ball Mills; Melangeur (M.22/RC); tempering kettles; DMW Temperers; Minispinners for hollow chocolate articles; a modern shell plant, including demolding, shell chocolate depositor, shell cooler, hot center cooler and backing chocolate depositor stations; molding plants, including mold heater, chocolate and cream depositor, shaking and cooling stations; enrober systems, particularly Temperstatic® enrobers; chocolate circulators; roam and tunnel coolers; multizone coolers and volvo pans.

Tables 1 and 2 are provided hereinbelow. Table 1 provides an analysis of cocoa powder using commonly quoted amounts of constituents. Table 2 provides an analysis of triglyceride composition of cocoa butters from the main growing areas.

TABLE 1
ANALYSES OF COCOA POWDER (VARIOUS QUOTED FIGURES)

| | Natural | 1 | 2 | 3 | Remarks |
|---|---|---|---|---|---|
| Moisture, & | 3.0 | 3.5 | 3.5 | 4.3 | Should not exceed 5.0% |
| Coca butter | 11.0 | 10.0 | 23.5 | 21.5 | depends on pressing |
| pH (10% suspension) | 5.7 | 7.1 | 6.7 | 6.8 | Depends on alkalization |
| Ash, % | 5.5 | 8.5 | 6.3 | 7.7 | Depends on alkalization |
| Water, soluble ash, % | 2.2 | 6.3 | — | 5.8 | Depends on alkalization |
| Alkalinity of water | 0.8 | 2.9 | 1.8 | 2.5 | Depends on alkalization |
| soluble ash as | | | | | |
| K₂O in original coco, % | | | | | |
| Phosphate (as P₂O₅), % | 1.9 | 1.9 | 1.4 | 2.0 | |
| Chloride (As NaCl), % | 0.04 | 0.9 | 0.7 | 1.1 | Salt occasionally added |
| | | | | | as flavor |
| Ash insoluble in 50% HCl | 0.08 | 0.01 | 0.06 | 0.09 | High figure shows bad |
| | | | | | bean cleaning |
| Shell, % (calculated to | | | | | |
| unalkalized nib) | 1.4 | 1.0 | 0.5 | 1.0 | Depends on efficiency of |
| Total nitrogen | 4.3 | 3.9 | 3.5 | 3.7 | winnowing |
| Nitrogen (corrected for | | | 2.8 | 3.0 | |
| alkaloids), % | 3.4 | 3.0 | | | |
| Protein | | | | | |
| Nitrogen corrected for | 21.2 | 18.7 | 17.5 | 18.7 | |
| alkaloids × 6.25), % | 2.8 | 2.7 | 2.3 | 2.3 | |
| Theobromine, % | | | | | |

TABLE 2
TRIGLYCERIDE COMPOSITION OF COCOA BUTTERS FROM
MAIN GROWING AREAS (KATTENBERG 1981)

| | | | | Polyun- |
|---|---|---|---|---|
| Bean Origin | Trisaturated | Monosaturated | Diunsaturated | saturated |
| Ghana | 1.4 | 77.2 | 15.3 | 6.1 |
| Ivory Coast | 1.6 | 77.7 | 16.3 | 4.4 |
| Cameroun | 1.3 | 75.7 | 18.1 | 4.9 |
| Brazin | 1.0 | 64.2 | 26.8 | 8.0 |

Having generally described the present invention, the same will be further illustrated by reference to certain examples which are provided for purposes of illustration and are not intended to be limitative.

### EXAMPLE

Chocolate was manufactured at pilot scale in the laboratory under each of the following gas treatments:

1. Air

2. Oxygen

3. Argon

4. Neon

5. Krypton

6. Xenon

7. Helium

8. Carbon dioxide

9. Nitrogen

The treatments were repeated wherein 5% air was admitted. The treatments were repeated wherein 10% air was admitted. The treatments were repeated wherein 20% air was admitted.

Additionally, several tests were made using decile mixtures of argon with 1 or 2 other noble gases, and with mixtures of nitrogen and noble gases.

Additionally, chocolate products were packaged in all of the above atmospheres.

Results were measured as:

1. GC/MS analyses of aromatic volatile flavor and fragrance components

2. Sensory evaluation panel

3. Color as measured by a Hunter Miniscan Colorimeter

4. Oxidative Surface Bloom

5. Viscosity

6. Moisture Content

7. Melting Point

8. An overall improvement score made by combining the above scores. The primary components are GC/MS oxidation measurements, taste and aroma panel measurement, and shelf life.

Gas was added by each of the following means: blanketing, injection into a shroud placed over the process step and equipment, injection into a pressure vessel under pressure wherein the step was accomplished, injection by sparging directly into the liquid or process milieu. The latter step was generally not satisfactory due to the viscosity of the product and its sensitivity to mechanical force.

The results of the packaging show that noble gases strongly inhibit oxidative discoloration and degradation, and better preserve aroma and flavor than nitrogen or other gases. An exception is helium which did not have an effect different from nitrogen. Further, the noble gases (Ar, Ne, Kr, Xe) had significant efficacy in improving quality of the chocolate even in the presence of oxygen, particularly when oxygen was present at 10% or less.

The processing study showed even more dramatic improvements than the packaging study, wherein treatment using noble gas improved the final quality of the product by a factor of 2 in terms of shelf life, color, aroma and flavor compared to typical processing in air. Processing using nitrogen showed only slight improvement compared to air, and this improvement disappeared in the case of admittance of as little as 5% air, whereas that amount of air did not remove the effect of argon or other noble gas. Again, only Ar, Ne, Kr and Xe were effective, He was not.

The best improvements were noted when the entire process from step 5-16 are subject to noble gas treatment, as well as packaging of the final product, but the more critical steps are 9-16 and packaging. The improvement in the first case is about 100%, in the second about 95%. Measurement of improvement at each step was made, with the following steps showing the greatest improvements: 5, 9, 10, 12, 13, 14, 16. The improvements we found were 10%, 10%, 25%, 25%, 10%, 10%, 40%, and are not strictly additive. The remainder of the noted improvement is gained by use of modified atmosphere packaging.

Argon was nearly as good (80-90%) in improvement of the process as Kr and Xe, and is preferable because of its lower cost. Where final product is valuable and gas volume used would not be excessive, combining argon with Kr or Xe as 90:10-95:5-99:1 percentage mixtures give better improvement still.

The following example is given as one proposed desirable practical optimum wherein argon is used at steps 5-11, Ar:Kr 95:5 is used in step 12, argon in steps 13-15, and Ar:Kr 90:10 in step 16. For packaging, the best result is found when Ar:Kr:Xe mixes are used, for example at 80:19:1.

A caution is made that because of the drying effects of controlled gas introduction, more care must be taken to ensure that moisture contents are correct, and additional water may be required to be added. We have found that adding water is best achieved through humidification of the noble gas atmosphere.

Examination of actual industrial-scale chocolate production equipment reveals that all are amenable to gas shrouding, blanketing or injection, so that in practical application, any degree of gas contact desired may be achieved.

It is again emphasized that the present invention may be used advantageously not only in conjunction with processes for producing chocolate, but also in storing chocolate or precursors thereof. The present invention may also be used to advantage in the production and/or storage of chocolate-containing products.

As used herein, the term “substantially” generally means at least 75%, preferably at least about 90%, and more preferably about 95%. This refers to not only duration of storage but also the volume of the containing means.

Having described the present invention, it will be apparent to one of ordinary skill in the art that many changes and modifications may be made to the above-described embodiments without departing from the spirit and the scope of the present invention.

What is claimed as new and desired to be secured by Letters Patent of the United States is:

1. A method of improving the aromas and/or the flavor of chocolate or a precursor thereof or a chocolate-containing product comprising injecting a gas or gas mixture into the chocolate or precursor thereof or chocolate-containing product in containing means or into the containing means, the gas or gas mixture comprising an element selected from the group consisting of argon, krypton, xenon and neon or a mixture thereof; substantially saturating the chocolate or precursor thereof or chocolate containing product with the gas or gas mixture; maintaining said saturation substantially throughout the volume of the containing means and during substantially all the duration that the chocolate, precursor chocolate-containing product is stored in said container.

2. The method according to claim 1, wherein said gas is injected in gaseous form or liquid form or both.

3. The method according to claim 1, wherein said wine is saturated to more than 50% volume of its full saturation level.

4. The method according to claim 1, wherein said wine is saturated to more than 70% volume of its full saturation level.

5. The method according to claim 1, wherein said wine is saturated to more than 80% volume of its full saturation level.

6. The method according to claim 1, wherein said gas mixture additionally comprises a gas selected from the group comprising nitrogen, oxygen, nitrous oxide, air, helium, carbon dioxide or mixtures thereof.

7. The method according to claim 6, comprising less than 50% volume of oxygen, carbon dioxide, or a mixture thereof.

8. The method according to claim 6, comprising less than 30% volume of oxygen, carbon dioxide, or a mixture thereof.

9. The method according to claim 6, comprising less than 20% volume of oxygen, carbon dioxide, or a mixture thereof.

10. The method according to claim 6, comprising less than 10% volume of oxygen, carbon dioxide, or a mixture thereof.

11. The method according to claim 1, wherein the gas mixture or the element of the gas mixture comprises 90% to 99% volume argon and 1% to 10% volume Xe and/or Kr.

12. The method according to claim 1, wherein the gas mixture or the element of the gas mixture comprises about 50% volume Ne and 50% volume He.

13. The method according to claim 1, wherein the gas mixture or the element of the gas mixture comprises about 5% to 10% volume Xe and 90% to 95% volume Kr.

14. The method according to claim 13, wherein the gas mixture comprises less than 2% volume of argon, oxygen, nitrogen, or a mixture thereof.

15. The method according to claim 1, wherein the temperature is comprised between 10% and 40° C.

16. The method according to claim 1, wherein the temperature is comprised between 10° C. and 30° C.

17. The method according to claim 1, wherein the pressure of the chocolate, precursor or chocolate-containing product is less than 10 atmosphere.

18. The method according to claim 1, wherein the pressure of the chocolate, precursor or chocolate-containing product is less than 3 atmosphere.

19. The method according to claim 1, wherein the pressure of the chocolate, precursor or chocolate-containing product is between 1 and 2 atmosphere.

20. The method according to claim 1, wherein the pressure of the chocolate, precursor or chocolate-containing product is about 1 atmosphere.

21. A method of improving a process for producing chocolate or a chocolate-containing product, which comprises injecting a gas or gas mixture into the chocolate or chocolate-containing product or precursor thereof in containing means in at least one step in a process for producing the same, the gas or gas mixture comprising an element selected from the group consisting of argon, krypton, xenon, neon and a mixture thereof; substantially saturating the chocolate or precursor thereof and chocolate-containing product with the gas or gas mixture; maintaining the saturation substantially throughout the volume of the containing means and during substantially all the duration of the process step.

22. The method according to claim 21, wherein said gas or gas mixture is used substantially throughout the entire process.

23. The method according to claim 21, wherein said gas is injected in gaseous form or liquid form or both.

24. The method according to claim 21, wherein said wine is saturated to more than 50% volume of its full saturation level.

25. The method according to claim 21, wherein said wine is saturated to more than 70% volume of its full saturation level.

26. The method according to claim 21, wherein said wine is saturated to more than 80% volume of its full saturation level.

27. The method according to claim 21, wherein said gas mixture additionally comprises a gas selected from the group comprising nitrogen, oxygen, nitrous oxide, air, helium, carbon dioxide or mixtures thereof.

28. The method according to claim 6, comprising less than 50% volume of oxygen, carbon dioxide, or a mixture thereof.

29. The method according to claim 6, comprising less than 30% volume of oxygen, carbon dioxide, or a mixture thereof.

30. The method according to claim 6, comprising less than 20% volume of oxygen, carbon dioxide, or a mixture thereof.

31. The method according to claim 6, comprising less than 10% volume of oxygen, carbon dioxide, or a mixture thereof.

32. The method according to claim 21, wherein the gas mixture or the element of the gas mixture comprises 90% to 99% volume argon and 1% to 10% volume Xe and/or Kr.

33. The method according to claim 21, wherein the gas mixture or the element of the gas mixture comprises about 50% volume Ne and 50% He.

34. The method according to claim 21, wherein the gas mixture or the element of the gas mixture comprises about 5% to 10% volume Xe and 90% to 95% volume Kr.

35. The method according to claim 13, wherein the gas mixture comprises less than 2% volume of argon, oxygen, nitrogen, or a mixture thereof.

36. The method according to claim 21, wherein the temperature is comprised between 0° C. and 40° C.

37. The method according to claim 21, wherein the temperature is comprised between 10° C. and 30° C.

38. The method according to claim 21, wherein the pressure of the chocolate, precursor or chocolate-containing product is less than 10 atmosphere.

39. The method according to claim 21, wherein the pressure of the chocolate, precursor or chocolate-containing product is less than 3 atmosphere.

40. The method according to claim 21, wherein the pressure of the chocolate, precursor or chocolate-containing product is between 1 and 2 atmosphere.

41. The method according to claim 21, wherein the pressure of the chocolate, precursor or chocolate-containing product is about 1 atmosphere.
